(19) United States
(12) Patent Application Publication
(10) Pub. No.: US 2026/0184287 A1
(43) Pub. Date: Jul. 2, 2026

(54) WIPER DEVICE, WIPER COMPRISING A WIPER DEVICE, AND METHOD FOR INSTALLING A WIPER DEVICE

(71) Applicant: Robert Bosch GmbH, Stuttgart (DE)

(72) Inventors: Stijn Truyens, Tienen (BE); Andrija Terentic, Belgrad (RS); Denis Parenta, Veternik (RS); Harald Rapp, Buehl (DE); Najdan Jocic, Pancevo (RS); Raf Greunlinx, Zolder (BE); Tanja Bosnic, Belgrad (RS)

(21) Appl. No.: 18/864,151

(22) PCT Filed: Mar. 6, 2023
(86) PCT No.: PCT/EP2023/055529

§ 371 Date: Nov. 8, 2024

(30) Foreign Application Priority Data
May 25, 2022 (DE) 10 2022 205 245.5

(51) Int. Cl. B60S 1/38

(52) U.S. Cl. CPC B60S 1/3805

(57) ABSTRACT

The invention relates to a wiper device comprising a wiper blade (10), at least one heating element (12), and a connection element (14) at least for connecting the heating element (12) to a heat energy source (60).

According to the invention, the connection element (14) forms a connection direction (16) which defines a minimum angle (18) of at least 45°, preferably at least 60°, together with a main extension direction (50) of the wiper blade (10) in a perpendicular projection onto a provided wiping plane (66) of the wiper blade (10).

### BACKGROUND

A wiper device comprising a wiper blade, having at least one heating element and a connection element at least for connecting the heating element to a heat energy source, has already been proposed.

### SUMMARY

The invention relates to a wiper device comprising a wiper blade, at least one heating element, and a connection element at least for connecting the heating element to a heat energy source.

According to the invention, the connection element forms a connection direction which defines a minimum angle of at least 45°, preferably at least 60°, together with a main extension direction of the wiper blade at least in a perpendicular projection onto a provided wiping plane of the wiper blade. The design of the wiper device according to the invention can advantageously provide low installation complexity. Advantageously, reliability during installation can be increased. Advantageously, complexity can be reduced.

The term “wiper blade” is preferably intended to mean at least one part, preferably a subassembly, of a wiper device, in particular a windshield wiper. Preferably, the wiper blade is intended for use on a vehicle. The wiper blade preferably forms a portion of the wiper device, in particular the windshield wiper. The wiper blade, in particular as part of the windshield wiper, is preferably configured for cleaning a surface, preferably a surface of a window, preferably a vehicle window, on a vehicle. Preferably, the wiper blade is coupled to a vehicle, preferably a wiper arm drive of the vehicle, for cleaning the windshield, preferably the vehicle windshield. Preferably, the wiping plane is formed by the vehicle windshield. Preferably, the wiper blade is formed from a wiper lip and at least one spring strip, which is provided to fix the wiper lip and/or to increase and/or ensure a stiffness of the wiper blade. An object being provided or designed for a specific function is preferably understood to mean that the object fulfills and/or performs this specific function in at least one application and/or operating state. An “operating state” is preferably to be understood as a state in which the wiper device is ready for operation for a wiping process and/or a wiping operation and/or is in a wiping operation, in which a wiper strip unit, preferably the wiper lip, of the wiper device, in particular of the windshield wiper, is preferably guided over a vehicle windshield and, in doing so, advantageously makes contact with the vehicle windshield.

Preferably, the at least one heating element is provided for heating the wiper device, in particular the wiper blade, in particular to supply thermal energy to the wiper blade for an increase in temperature. Preferably, the heating element is at least substantially formed from a metallic, in particular electrically conductive, material. Preferably, the heating element comprises at least one heating wire and/or heating rod and/or heating spiral and/or heating coil and/or heating tube or a comparable designed component. Preferably, the at least one heating element comprises a connection element, which is provided for supplying heating energy, in particular electric heating energy, to the heating element. Preferably, the connection element represents the interface between the heating element and the, in particular electrical, heating energy source. A “heating energy source” is to be understood in particular to mean an electrical and/or chemical and/or thermal and/or mechanical energy store, in particular a battery and/or a rechargeable battery. Furthermore, it is conceivable that the heat energy source is configured as an energy converter, in particular a generator.

A “connection direction” is to be understood in particular as a direction in which an in particular electrical connection is mechanically coupled to the connection element, in particular to supply the heating element with heating energy. In particular, the connection element has a minimum, in particular acute, angle to the main extension direction of the wiper blade of at least 15°, advantageously at least 30°, preferably at least 45°, preferably at least 60°, and more preferably at least substantially 90°. A “perpendicular projection” is to be understood in particular as an orthogonal projection which maps points on a plane, in particular the intended wiping plane, such that the connection line between the point and a point, in particular an image point, projected onto the plane, in particular the wiping plane, is perpendicular to the projection plane, in particular the wiping plane. The term “main extension direction” of an object is in this context in particular understood to mean a direction which extends parallel to a longest edge of a smallest geometrical cuboid, which only just completely encloses the object.

Furthermore, it is proposed that the angle that the connection direction defines is at least substantially 90° together with the main extension direction of the wiper blade, at least in the perpendicular projection onto the provided wiping plane of the wiper blade. Installation can advantageously be simplified. Preferably, the connection direction is limited to a direction of the wiper blade oriented at least substantially perpendicular to the main extension direction. The term “substantially 90°” is in particular intended here to define an orientation of a direction relative to a reference direction, wherein the direction and the reference direction, in particular when viewed in a projection plane, enclose an angle of 90° and the angle has a maximum deviation of in particular less than 3°, advantageously less than 2°, and in particular advantageously less than 1°.

It is further proposed that the connection direction of the connection element is at least substantially parallel to the provided wiping plane of the wiper blade. Installation can advantageously be simplified. In particular, the projection of the connection direction of the connection element and the connection element coincide. The term “substantially parallel” is in particular intended here to be understood to mean an orientation of a direction relative to a reference direction, in particular in a plane, wherein the direction has a deviation from the reference direction of in particular less than 8°, advantageously less than 5°, and in particular advantageously less than 2°.

Furthermore, it is proposed that the connection element is configured as a positive locking plug. Installation can advantageously be simplified. A connection can be reliably fixed particularly advantageously. Advantageously, safety for an operator can be increased. In particular, a “positive locking plug” is to be understood to mean a connector for connecting and/or disconnecting wires, in particular electrical ones, which orients and/or connects the connecting parts by means of a positive lock between the positive locking connecting parts. Preferably, the positive locking plug is provided to establish a positive locking connection between the connection element and the heat energy source, in particular a non-destructive and/or tool-free detachable connection. Preferably, the positive locking plug is made of a plastic and/or a metallic material. The term “positive locking” is in particular understood to mean that contiguous faces of components connected to one another in an interlocking manner exert a holding force on one another that acts in the normal direction of the faces. In particular, the components are in geometrical engagement with one another. In particular, the positive locking plug is provided to prevent the connection element from loosening in a mounted state.

Furthermore, it is proposed that the connection element is configured to be additional to a mechanical attachment to a wiper arm. Advantageously, a complexity, in particular an installation complexity, can be reduced. Preferably, an electrical coupling, in particular of the heating element to the heating energy source, takes place at the same time as the mechanical attachment, in particular the positive locking coupling of the wiper blade to the wiper arm. Preferably, the electrical connection element is configured with the mechanical connection element as a component, in particular an integral connection element. It is conceivable that the wiper device may comprise a further connection element. The further connection element could be configured as a purely mechanical connection element. The further connection element may be provided to reinforce the mechanical connection between the wiper device and the wiper arm. The further connection element may be arranged adjacent to the connection element in the main extension direction of the wiper blade. The further connection element could be configured as a connection recess, in particular a cylindrical one. Preferably, the further connection element, in particular the connection recess, is provided for guiding and/or positioning, in particular during an installation operation. Preferably, the further connection element, in particular the connection recess, is provided to improve the stability of the mechanical connection between the wiper blade and the wiper arm and/or to prevent a torsion load on the connection element, in particular the positive locking plug. Advantageously, integrally should also be understood as in one piece. The term “in one piece” is in particular understood to mean shaped in one piece. Preferably, this one piece is produced from a single blank, a mass and/or a cast, particularly preferably in an injection-molding method, in particular a single- and/or multi-component injection-molding method.

Furthermore, it is proposed that the connection directions of the connection element for the mechanical attachment to the wiper arm and for connection to the heat energy source are identical. Installation can advantageously be simplified. Preferably, the connection direction of the connection element to the mechanical attachment on the wiper arm and to the connection with the heat energy source is at least substantially parallel and aligned in the same direction. In particular, the connection directions of the connection element and the further connection element can also be aligned at least substantially parallel to one another.

Furthermore, it is proposed that the heating element is arranged in the main extension direction of the wiper blade over at least a large part of a total longitudinal extension of the wiper blade. Advantageously, a particularly uniform heating energy distribution is thereby to be ensured. The term “at least a large part” should in particular be understood to mean at least 51%, preferably at least 70%, advantageously at least 80%, and particularly advantageously at least 90%. In particular, a “longitudinal extent” is to be understood to mean an extent of an object parallel to a main extension direction of the object.

Furthermore, it is proposed that the heating element is connected to the wiper blade in a material locking fashion. Advantageously, a high level of security against unintentional loosening of the connection can be achieved. Preferably, the heating element is connected to the spring strip of the wiper blade in a material locking fashion. However, it is conceivable that the heating element may be connected to the wiper lip and/or a further component of the wiper blade in a material locking fashion. The term “connected in a material locking fashion” is intended to mean that the mass parts are held together by atomic or molecular forces, such as in soldering, welding, gluing, and/or vulcanization.

Furthermore, it is proposed that the connection element is formed integrally with a wiper blade adapter and a positive locking installation of the wiper blade with a wiper arm. Advantageously, component complexity can be reduced. The term “integral” is in particular understood to mean connected at least by substance-to-substance bonding, e.g., by a welding process, an adhesive bonding process, a process of molding on, and/or another process that appears advantageous to the skilled person, and/or advantageously formed in one piece, e.g., by production from a casting and/or by production in a single- or multi-component injection molding process and advantageously from a single blank. In particular, the connection element may be formed monolithically with the wiper blade adapter.

Furthermore, it is proposed that the connection element comprises a guide unit, in particular different from the connecting pins, which guides a movement of the wiper blade along the connection direction when the wiper blade is coupled to a wiper arm and/or the heating element is coupled to the heat energy source. Installation can advantageously be simplified. Particularly advantageously, damage to the connecting pin, in particular as a result of a crooked and/or slanted installation, can be prevented. The stability of the connection can advantageously be increased. A “connecting pin” is intended in particular to mean a pin, in particular a wire-like electrically conductive terminal, which is provided for a transmission of electrical energy and/or data. Preferably, the connecting pins are formed from an electrically conductive material, in particular copper and/or steel. Preferably, the guide unit, in particular mechanical guide unit, is provided to simplify installation, in particular of the connecting pin. Preferably, the further connection element comprises a further guide unit. Preferably, the mechanical guide element is configured as a positive locking element, in particular a positive locking plug, which surrounds, in particular encloses, the connecting pins. Preferably, the mechanical guide element is configured as a rectangular element with rounded edges and/or corners. Preferably, the mechanical guide element, in particular in the connection direction, comprises a connection opening, which allows an electrical coupling of the connecting pins. Preferably, at least one, in particular positive and/or raised, latching element is arranged on the outer side, in particular the outer circumference of the mechanical guide element, to fix the positive locking connection. Preferably, the positive locking plug is formed as the mechanical guide element. Preferably, the further connection element, in particular the connection recess, is formed by the inner lateral surface of the cylindrical connection recess, which is delimited by the connection element.

Furthermore, an advantageously designed wiper having the wiper device and the wiper arm is proposed.

Furthermore, a method for installing the wiper device, in particular with the wiper arm of the wiper, is proposed, wherein the connection element and a mechanical attachment for attaching the wiper blade to a wiper arm are connected to the wiper arm in one, in particular single, common installation step. Installation can advantageously be simplified. Advantageously, complexity can be reduced. Preferably, the connecting pins are centered in the installation step, in particular by the mechanical positive locking connection, to couple the electric heating energy supply with the heating energy source. In particular, the installation of the wiper blade, which can be carried out by the proposed method, in which a mechanical and an electrical connection is created at the same time, only requires a single installation movement in a single connection direction.

The wiper device according to the invention is not intended to be limited to the application and embodiment described above. In particular, the wiper device according to the invention can have a number of individual elements, components, and units as well as method steps that differ from a number mentioned herein in order to fulfill a mode of operation described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the drawings hereinafter. The drawings illustrate an exemplary embodiment of the invention. The drawings, the description, and the claims contain numerous features in combination. A person skilled in the art will appropriately also consider the features individually and combine them into additional advantageous combinations.

### Shown are:

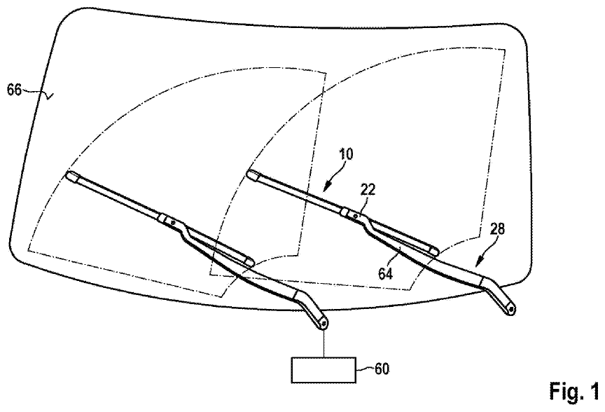

FIG. 1 a schematic illustration of a wiper of the wiper device,

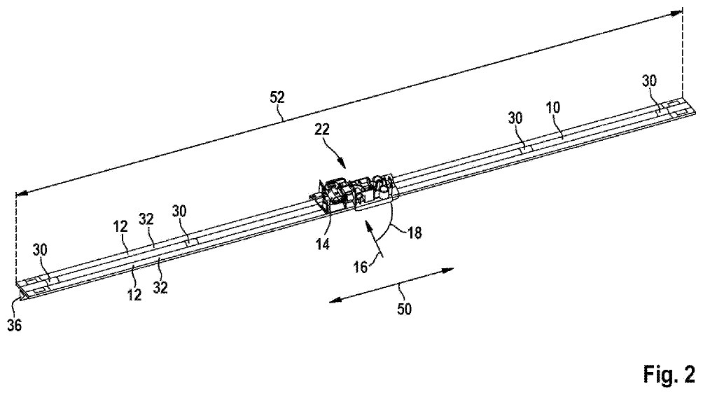

FIG. 2 a schematic perspective illustration of the wiper device,

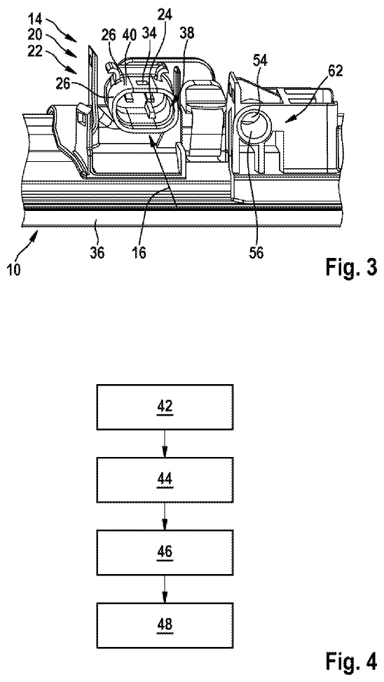

FIG. 3 a schematic perspective illustration of a portion of the wiper device with a connection element; and

FIG. 4 a schematic flow diagram of a method for installing the wiper device to a wiper arm.

### DETAILED DESCRIPTION

FIG. 1 schematically shows a wiper 28 having a wiper device. The wiper 28 comprises a wiper arm 64. The wiper device has a wiper blade 10. The wiper blade 10 is releasably connected to the wiper arm 64. The wiper arm 64 is provided to transmit a wiping movement, for example generated by a drive unit (not shown), to the wiper blade 10. The wiping movement causes the wiper blade 10 to move back and forth in a wiping plane 66. The wiping plane 66 is typically defined by a view panel to be wiped.

FIG. 2 shows a schematic perspective view of a wiper device. The wiper blade 10 comprises two spring rails 32. The wiper blade 10 has a wiper lip 36. The wiper device has a heating element 12. The heating element 12 comprises an electrically insulating jacket. The jacket has a good thermal conductivity. The heating element 12 is arranged in the main extension direction 50 of the wiper blade 10 over at least a large part of a total longitudinal extension 52 of the wiper blade 10. The heating element 12 comprises at least two heating wires arranged in parallel. In an alternative embodiment, the heating element 12 could also comprise curved heating wires. The heating element 12 is connected to the wiper blade 10 in a material locking fashion. The heating element 12 is connected to the spring strips 32 in a material locking fashion. The heating element 12 is glued to the spring strips 32. The heating element 12 could also be vulcanized to the wiper blade 10. The heating element 12 could also be wrapped around the spring strips 32. The heating element 12 arranged on the two spring strips 32 is connected via bridges 30. The bridges 30 are provided to increase the stiffness of the heating element 12. The heating element 12 is provided to supply thermal energy to the wiper blade 10 to increase the temperature. The heating element 12 converts electrical energy into heat. The electrical energy for supplying the heating element 12 is provided by a heat energy source 60.

The wiper device comprises a connection element 14. The connection element 14 is provided for connecting the heating element 12 to the heat energy source 60. The connection element 14 is additionally configured to mechanically attach the wiper blade 10 to the wiper arm 64. The connection element 14 forms a connection direction 16. The connection direction 16 has a minimum angle 18 of 90° with the main extension direction 50 of the wiper blade 10 in a perpendicular projection onto a provided wiping plane 66 of the wiper blade 10. The minimum angle 18 could also be at least 45°. The minimum angle 18 could also be at least 60°. Furthermore, the connection direction 16 of the connection element 14 is parallel to the provided wiping plane 66 of the wiper blade 10.

FIG. 3 schematically shows an enlarged section of the wiper device in a connection area to a connection to the wiper arm 64. The wiper device has a wiper blade adapter 22. The wiper blade adapter 22 is provided for connecting the wiper blade 10 to the wiper arm 64 or to a wiper arm adapter of the wiper arm 64. The connection element 14 is formed integrally with the wiper blade adapter 22. The connection element 14 is configured as a positive locking plug 20. The positive locking plug 20 comprises a positive latching element 34. The positive latching element 34 is provided to be connected to a corresponding negative latching element (e.g., the wiper arm 64 or the wiper arm adapter, not shown) in a positive locking manner. The connection element 14 is made of a plastic.

The wiper blade adapter 22 is connected to the wiper blade 10. The wiper blade adapter 22 is provided for positive locking installation of the wiper blade 10 with the wiper arm 64. The wiper blade adapter 22 comprises the connection element 14. The connection element 14 is configured to mechanically attach the wiper blade 10 to the wiper arm 64. The connection element 14 is provided for an electrical connection of the heating element 12 to the heat energy source 60. The connection direction 16 of the connection element 14 for mechanical attachment to the wiper arm 64 and for connecting the heating element 12 to the heat energy source 60 are identical.

The connection element 14 has three connecting pins 24. The connection element 14 could also have one of three different numbers of connecting pins 24. The connecting pins 24 are made of an electrically conductive material. It is conceivable that the connection element 14 comprises further connections, which are provided for data transmission. The connection element 14 comprises a guide unit 26. The guide unit 26 is configured differently from the connecting pins 24. The guide unit 26 guides a movement of the wiper blade 10 along the connection direction 16 when the wiper blade 10 is coupled to the wiper arm 64. The guide unit 26 guides the electrical connection of the connection element 14 to the heat energy source 60. The guide unit 26 is configured as a positive locking element enclosing the connecting pins 24. The guide unit 26 is formed as the positive locking plug 20. The guide element 26 is configured as a rectangular element with rounded edges and/or corners. The guide unit 26 could also be configured with chamfered corners.

The wiper device comprises a further connection element 62. The further mechanical connection element 62 is formed by a connection recess 54. The connection recess 54 has a cylindrical shape. The connection recess 54 is delimited by the wiper adapter 22. The connection element 14 and the further connection element 62 are arranged adjacent to each other when viewed in the main extension direction 50 of the wiper blade 10.

The further connection element 62 comprises a further guide unit 56. The further guide unit 56 is formed by the lateral surface of the wiper blade adapter 22 which delimits the connection recess 54. The further guide unit 56 is provided to guide an installation movement along the connection direction 16 of the connection element 14. The further guide unit 56 is provided for positioning the electrical connection to a corresponding electrical connection (not shown). The further guide unit 56 fixes a position of the connection element 14 to a corresponding connection element (not shown) in all directions different from the connection direction 16. A latching connection between the positive latching element 34 and the corresponding negative latching element (not shown) fixes the connection element 14 with the corresponding connection element (not shown) in the connection direction 16. The latching connection with the positive latching element 34 and the corresponding negative latching element (not shown), together with the further connection element 62, fixes the connection element 14 and the corresponding connection element (not shown) in all directions.

The guide unit 26 comprises a connection opening 38 in the connection direction 16. The connection opening 38 is provided for electrical coupling of the connecting pins 24. A latching element 34 is arranged on the outer side and/or an outer circumference 40 of the guide unit 26. The positive latching element 34 forms a positive locking connection with the corresponding negative latching element (not shown). The latching element 34 fixes the mechanical connection of the wiper blade 10 to the wiper arm 64 in the connection direction 16. The latching element 34 fixes the electrical connection between the heating element 12 and the heat energy source 60 in the connection direction 16. The connection element 14 for mechanically attaching the wiper blade 10 to the wiper arm 64 and for electrically connecting the heating element 12 to the heat energy source 60 is connected to the corresponding connection element (not shown) in a common installation step 48.

FIG. 4 shows a schematic flowchart of a method for installing the wiper device with the wiper arm 64. In at least one method step 42, the wiper arm 64 or a connection element (not shown) of a wiper arm adapter (not shown) of the wiper arm 64 is provided. In at least one further method step 44, the wiper device is provided. In at least one further method step 46, the wiper device and the wiper arm 64 or the wiper arm adapter are moved towards each other in the connection direction 16. In at least one common installation step 48, the connection element 14 of the wiper device and a mechanical attachment of the wiper device provided for attaching the wiper blade 10 to the wiper arm 64 is connected to the wiper arm 64 or to the wiper arm adapter. The mechanical attachment of the wiper device is at least in part also carried out via the connection element 14. In addition, an additional mechanical attachment may be made in the same common installation step 48 via the further connection element 62. A fixation in the connection direction 16 is thereby generated by means of the connection element 14. A fixation perpendicular to the connecting direction 16 is thereby generated by means of the further connection element 62. An electrical connection of the heating element 12 to the heat energy source 60 is also generated by means of the connection element 14. The movement of the wiper arm 64 and the wiper device 16 towards each other in the connection direction simultaneously results in the mechanical fixation of the two components of the wiper 28 and the electrical connection of the heating element 12. In a further step, the wiper arm adapter could be closed off from the outside with a cover cap not shown in the drawings.

1. A wiper device comprising a wiper blade (10), at least one heating element (12), and a connection element (14) at least for connecting the heating element (12) to a heat energy source (60), wherein the connection element (14) defines a connection direction (16) which defines a minimum angle (18) of at least 45°, together with a main extension direction (50) of the wiper blade (10) in a perpendicular projection onto a provided wiping plane of the wiper blade (10).

2. The wiper device according to claim 1, wherein the minimum angle (18) that the connection direction (16) defines is at least substantially 90° at least in the perpendicular projection onto the provided wiping plane (66) of the wiper blade (10) together with the main extension direction (50) of the wiper blade (10).

3. The wiper device according to claim 1, wherein the connection direction (16) of the connection element (14) is at least substantially parallel to the provided wiping plane of the wiper blade (10).

4. The wiper device according to claim 1, wherein the connection element (14) is configured as a positive locking plug (20).

5. The wiper device according to claim 1, wherein the connection element (14) is configured in addition to a mechanical attachment to a wiper arm (64).

6. The wiper device according to claim 5, wherein the connection directions (16) of the connection element (14) are identical to the mechanical fastening to the wiper arm (64) and to the connection to the heat energy source (60).

7. The wiper device according to claim 1, wherein the heating element (12) is arranged in the main extension direction (50) of the wiper blade (10) over at least a part of a total longitudinal extension (52) of the wiper blade (10).

8. The wiper device according to claim 1, wherein the heating element (12) is connected to the wiper blade (10) in a material locking fashion.

9. The wiper device according to claim 1, wherein the connection element (14) is formed integrally with a wiper blade adapter (22) and to a positive locking installation of the wiper blade (10) having a wiper arm (64).

10. The wiper device according to claim 1, wherein the connection element (14) comprises a guide unit (26), which guides a movement of the wiper blade (10) along the connection direction (16) when the wiper blade (10) is coupled to a wiper arm (64) and/or the heating element (12) is coupled to the heat energy source (60).

11. A wiper (28) having a wiper device according to claim 1 and having at least a wiper arm (64).

12. A method for installing a wiper device having a wiper blade (10), with at least one heating element (12) and with a connection element (14) at least for connecting the heating element (12) to a heat energy source (60), wherein the connection element (14) and a mechanical attachment for attaching the wiper blade (10) to a wiper arm (64) are connected to the wiper arm (64) in a common installation step (48).

13. The wiper device according to claim 1, wherein the minimum angle (18) is at least 60°.

14. The wiper device according to claim 10, wherein the guide unit (26) is different from connecting pins (24).
